(19) United States
(12) Patent Application Publication
(10) Pub. No.: US 2005/0224638 A1
(43) Pub. Date: Oct. 13, 2005

(54) Non-flammable lifting medium for LTA craft, and LTA craft buoyed thereby

(76) Inventor: Thomas John Goodey, London (GB)

Correspondence Address: THOMAS GOODEY;ALOM GROUP, SAMAJAYA INDUSTRIAL ZONE, 1 ALOM WAY, KUCHINE, SARANAK, 93450, MY

(21) Appl. No.: 10/792,672

(22) Filed: Mar. 4, 2004

(51) Int. Cl. B64B 1/02

(52) U.S. Cl. 244/30

(57) ABSTRACT

A lifting medium for an LTA craft is disclosed which includes a mixture of hydrogen and a quench gas which has a fire extinguishing action. This quench gas may be CF₃Br, CF₂ClBr, CF₃—CHF—CF₃, CHF₃, C₄F₁₀, CF₃CF₂H, CF₃CH₂CF₃, CF₃I, CHClFCF₃, or a mixture of two or more of these. An LTA craft buoyed by this lifting medium is also disclosed. The LTA craft may comprise an envelope comprising a main chamber, a vent chamber generally above the main chamber and separated therefrom by a separating membrane, and a first pressure relief valve opening between the vent chamber and the external atmosphere, which opens at a certain first threshold pressure. There may be further comprised means for ripping the separating membrane, or a second pressure relief valve opening between the main chamber and the external atmosphere, the second pressure relief valve opening at a second threshold pressure which is substantially greater than the first threshold pressure, or a flexible tube fitted to lead from the outside of the first pressure relief valve outward away from the envelope. The main chamber may be filled with the above lifting medium, and the vent chamber may be filled with helium or with hydrogen.

### BACKGROUND OF THE INVENTION

1. Field of the Invention

The present invention relates to a high-performance and cheap non-flammable lift gas mixture medium for an airship or balloon, and to an LTA craft buoyed thereby.

2. Background Art

The term “lighter than air craft”, hereinafter abbreviated as “LTA craft”, is in general use in reference to any aircraft for which a considerable proportion of its support in the atmosphere is provided, not by dynamic aerodynamic lift induced by motion relative to the air, but instead by buoyancy. This buoyancy is generated by a large and usually flexible container (the so called “envelope”) which is filled with a gas (the “lift gas”) whose density is substantially less than that of normal atmospheric air. Such LTA craft are termed “airships” when they are provided with means for propulsion through the atmosphere, or are termed “free balloons” when they are left to float freely in the atmosphere without any means for propulsion relative thereto.

In the prior art various lighter-than-air gases have been used as lift gases for filling the envelope of such a craft. Specifically, hydrogen, helium, methane, ammonia, and heated air have been utilized; and steam has also been proposed. Each of these lift gases has its advantages and disadvantages, which will now be discussed, bearing in mind that the effective molecular weight of air is about 29 (air being composed of approximately 80% N₂ with molecular weight of 28 and approximately 20% O₂ with molecular weight of 32, with some traces of CO₂ which is heavier and lesser traces of noble gases which are lighter) and that the mass of a cubic meter of air at the temperature (15° C.) and pressure (1013.25 hPa) of the ISA (International Standard Atmosphere) at sea level is 1.225 kilograms, so that its weight is 12.02 newtons.

(1) Hydrogen as a Lift Gas

Hydrogen (H₂) was the first gas other than heated air to be used as a lift gas. It is cheap and easy to make, even in the field, and its molecular weight of 2 means that it offers superb lifting performance of 11.18 newton/m³ at sea level ISA, but it suffers from the great disadvantage of being very flammable. Accordingly, although hydrogen was the mainstay for providing lift during the heyday of airships, nowadays hydrogen is no longer used in practice in airships as a lift gas, due to the risk of ignition and consequent catastrophic fire. Even for free balloons hydrogen is little used nowadays, again for reasons of safety.

(2) Helium as a Lift Gas

Almost all airships nowadays use helium (He) for lift. Helium has a (monoatomic) molecular weight of 4 and accordingly it provides 10.36 newton/m³ of lift at sea level ISA, and it is completely safe because it is inert. However helium is so costly that it must be stringently conserved. The cost of a single fill of helium lift gas is nowadays a significant factor in the deployment of an airship. Furthermore, since helium is an inert element and does not form compounds, helium gas cannot be manufactured chemically from any solid or liquid precursor. Also the liquefaction of helium requires extremely low temperature. Accordingly it is difficult to provide helium in the field, since the only practicable way of handling it after production is to store it in a compressed state in cylinders which are expensive, heavy, and unwieldy.

(3) Other Lift Gases

Methane (CH₄, or coal gas) has occasionally been used as an LTA lift gas, both by itself and in mixtures with hydrogen. However methane is flammable and offers no real safety advantage as compared with hydrogen, and its molecular weight of 16 means that it provides 5.39 newton/m³ of lift at sea level ISA—less than half the lift of hydrogen. Methane has no particular merit nowadays as a lift gas or as a component thereof.

Ammonia (NH₃) has been used as lift gas for free balloons. Due to its molecular weight of 17 it provides lift of 4.97 newton/m³ at sea level ISA, i.e. rather less than half the lift of hydrogen, and it is substantially non-flammable. Furthermore it is quite convenient to transport and supply in the field, because it can easily be liquefied at ambient temperature under moderate pressure. Moreover, it is relatively cheap. However ammonia is somewhat toxic and corrosive, as well as being malodorous, and accordingly it has not found great favor in practice as a lift gas.

Heated air can be used for providing lift for an LTA craft, because its density at ambient pressure is reduced from that of the surrounding air in proportion to the ratio between its absolute temperature and ambient. If hot air is to be used, this hot air must be continually reheated. Hot air is very cheap and easy to produce in the field, and its use and production are reasonably safe. Free balloons lofted by hot air are common nowadays, and hot air airships are also sometimes used. The chief disadvantage of hot air as a lifting gas, however, is the poor lift which it provides. In practice the average temperature of the hot air within the envelope varies between about 100° C. and about 120° C., i.e. between about 373K and about 393K, and 120° C. is typically the maximum operationally allowed temperature. Since the outside air temperature at sea level ISA is 288K, this means that the lift provided by one cubic meter of hot air varies from about 2.74 newtons to about 3.21 newtons—around a quarter of the lift which would be provided by hydrogen. This means that the envelope required for lifting a given payload needs to be comparatively large.

Steam (H₂O in vapor form) has been suggested as an LTA lift gas. Due to its molecular weight of 18 and its temperature of 100° C., it would provide lift of 6.26 newton/m³ at sea level ISA, i.e. rather more than half the lift of hydrogen, and it is substantially non-flammable. Furthermore it would be very convenient to supply in the field, and extremely cheap. However steam lift gas would need to be continually reheated, like heated air. As yet steam has not been used in practice as an LTA lift gas.

The Hydrogen-Helium Dilemma

Surveying the field of LTA lift gases as a whole, it is evident that gases other than helium and hydrogen provide too little lift to be considered for serious craft. Moreover, hydrogen is the ideal LTA lift gas in all respects other than that of flammability. Conversely, as a lift gas, helium is markedly inferior to hydrogen in all respects, except that of ignition safety. In summary:

Hydrogen is cheap, easy to provide near the point of use by chemical processes from solid or liquid precursors, and offers the best possible lift value of 11.18 N/m³; but its disadvantage is that it is flammable.

Helium is very expensive, difficult to store and transport, and offers a substantially lower lift value of 10.36 N/m³; but it is absolutely safe.

(It is well known in the art that, although the gross lift of helium is only 7% less than that of hydrogen, in application in an actual LTA craft, this translates to 40% less net payload or more, because of the burden of the structural overhead which is fixed. Accordingly the somewhat lower lift of helium is a more serious disadvantage than at first might appear.)

Hydrogen Fire Countermeasures

It has been conceived of in the past to reduce the flammability of hydrogen lift gas by adding a vapor of a substance which itself is flammable. British Patent Specification 294,958 (1927) proposes such a lifting medium for a balloon or an airship, in which a quantity of a compound having a theoretical flame propagation temperature higher than that of hydrogen—such as benzene, an alcohol, or a petroleum hydrocarbon—is added to hydrogen. This document also mentions the concept of reducing the explosive potential of hydrogen by the addition of acetylene or hexane vapor; and this matter is discussed in British Patent Application 18,056/10.

However, although such expedients may reduce the flammability of the mixture as compared to pure hydrogen, it is not conceivable that such a lifting medium will be totally non-flammable, so its danger in use is not obviated, although it is alleviated.

A Typical Airship Prior Art

FIG. 1 is a schematic longitudinal sectional view showing a prior art non-rigid airship whose main volume is filled with helium. The structure of this prior art airship will be explained as a reference point of departure for the subsequent description of the preferred embodiments of the present invention.

This prior art airship comprises an envelope generally designated as 1. An empennage 2 is provided at the rear end of the envelope 1, and a car 3 hangs below the envelope 1. The car 3 comprises a propeller 4 which is driven by an internal combustion engine 5. An air blower 6 is also provided within the car 3, and this blower 6 feeds air at a certain pressure through a conduit 7. A separating membrane 8 extends across a lower portion of the envelope 1, and thereby a ballonet volume 9 is defined at said lower envelope portion. The air supply conduit 7 opens into this ballonet volume 9. And a pressure relief valve 10 is provided at an upper portion of the main volume of the envelope 1.

In use, the main volume of the airship 1 is filled with helium gas He, as indicated in the figure. (Due to its high cost, this helium gas should only be vented in emergency.) And the blower 6 is operated so as to impel air at a certain pressure into the ballonet 9. Thereby, in a per se known manner, the envelope 1 is continually maintained at a suitable standard operating pressure, even when the airship ascends or descends in the atmosphere so that the mass of helium gas He expands and contracts. In detail, when the airship descends, the helium mass He contracts along with the increase in ambient pressure, and in tandem therewith a certain amount of air is driven through the conduit 7 into the ballonet 9 by the blowing force of the blower 6, so that the contracting helium mass He within the envelope 1 is squeezed upwards and maintained at substantially constant gauge pressure (the “standard operating pressure”) relative to the outside air, with the membrane 8 raising further away from the bottom of said envelope 1. Conversely, when the airship ascends, the helium mass He expands along with the drop in ambient pressure, and along therewith a certain amount of air is expelled from the ballonet 9 through the conduit 7 against the blowing force of the blower 6 which is overcome, so that more room is made available for the expanding helium mass He within the envelope 1, with the membrane 8 lowering towards the bottom of said envelope 1, and as a consequence, again, said helium mass He is maintained at the standard operating pressure relative to the outside air.

And when the volume of the ballonet 9 has dropped to zero so that it is completely collapsed, the mass of helium He is occupying the entire volume of the envelope 1. (This situation is not shown in the figure.) At this point the airship has reached its “pressure ceiling”, and it is not supposed to ascend further. However, if inadvertently or due to extreme weather conditions or the like the airship does in fact ascend further, the above described process for accommodating increase of volume of the helium mass He cannot continue, because there is no more space remaining in the envelope 1. Thus, if no means were provided for relieving the envelope 1, there would be a danger of it bursting. The pressure relief valve 10 is provided to prevent this. It is set to open at a pressure well below the burst pressure of the envelope 1, but well above its standard operating pressure.

In other words, when the airship rises above its pressure ceiling, it is better to vent a certain amount of helium, rather than for the envelope 1 to burst (which would of course lose all the helium). Therefore the pressure relief valve 10 is provided to open at an appropriate pressure for protecting the envelope 1.

### SUMMARY OF THE INVENTION

The present invention has been conceived in the light of the above described problems, and its primary objective is to provide a lifting medium for an LTA craft, which overcomes the disadvantages outlined above.

It is a further objective of the present invention to provide a lifting medium for an LTA craft, which is safe.

It is a further objective of the present invention to provide a lifting medium for an LTA craft, which is at least to some extent non-flammable.

It is a further objective of the present invention to provide a lifting medium for an LTA craft, which provides excellent lifting performance.

It is a further objective of the present invention to provide a lifting medium for an LTA craft, which is cheap.

It is a further objective of the present invention to provide a lifting medium for an LTA craft, which can be easily deployed in the field.

It is a further objective of the present invention to provide a lifting medium for an LTA craft, which is environmentally acceptable.

It is a yet further objective of the present invention to provide an LTA craft lofted by such a lifting medium.

It is a yet further objective of the present invention to provide such an LTA craft, in which venting of the lifting medium during use is rendered unlikely.

According to the present invention, the above and other objectives are attained by a lifting medium for an LTA craft, comprising a mixture of hydrogen and a quench gas which has a fire extinguishing action. This quench gas may be CF₃Br, CF₂ClBr, CF₃—CHF—CF₃, CHF₃, C₄F₁₀, CF₃CF₂H, CF₃CH₂CF₃, CF₃I, CHClFCF₃, or a mixture of two or more of these.

Moreover, according to another aspect of the present invention, the above and other objectives are attained by an LTA craft buoyed by a gas of the above type, or by an LTA craft comprising an envelope containing a gas of the above type.

And, according to yet another aspect of the present invention, the above and other objectives are attained by an LTA craft comprising an envelope comprising a main chamber, a vent chamber generally above the main chamber and separated therefrom by a separating membrane, and a first pressure relief valve opening between the vent chamber and the external atmosphere, which opens at a certain first threshold pressure. There may be further included means for ripping the separating membrane, or a second pressure relief valve opening between the main chamber and the external atmosphere, the second pressure relief valve opening at a second threshold pressure which is substantially greater than the first threshold pressure, or a flexible tube fitted to lead from the outside of the first pressure relief valve outward away from the envelope. The main chamber may be filled with the above lifting medium, and the vent chamber may be filled with helium or with hydrogen.

### BRIEF DESCRIPTION OF THE DRAWINGS

FIG. 1 is a schematic longitudinal sectional view showing a prior art non-rigid airship, whose main volume is filled with helium, and whose envelope is fitted with an overpressure valve.

FIG. 2 is a schematic longitudinal sectional view of an airship according to a first preferred embodiment of the present invention, whose main volume is filled with a lifting medium which is a mixture of hydrogen and a quench gas.

FIG. 3 is a schematic longitudinal sectional view of an airship according to a second preferred embodiment of the present invention, which is similar to the FIG. 2 airship, but additionally incorporates a vent gas chamber filled with helium, into which the overpressure valve opens.

FIG. 4 is a schematic longitudinal sectional view of an airship according to a third preferred embodiment of the present invention, which is similar to the FIG. 3 airship, but additionally incorporates arrangements for ripping the vent gas chamber.

FIG. 5 is a schematic longitudinal sectional view of an airship according to a fourth preferred embodiment of the present invention, which is similar to the second preferred embodiment FIG. 3 airship, but additionally incorporates a second overpressure valve opening into its main volume.

FIG. 6 is a schematic longitudinal sectional view of an airship according to a fifth preferred embodiment of the present invention, which is similar to the second preferred embodiment FIG. 3 airship, except for the fact that its vent gas chamber is filled with hydrogen.

FIG. 7 is a schematic longitudinal sectional view of an airship according to a sixth preferred embodiment of the present invention, which is similar to the second preferred embodiment FIG. 3 airship except in that, above its overpressure valve, it is provided with a vent tube (shown in the stowed position).

FIG. 8 is another view of this sixth preferred airship embodiment of the present invention, shown in its state with the vent tube deployed to vent hydrogen from the vent gas chamber through the overpressure valve.

### DESCRIPTION OF THE PREFERRED EMBODIMENTS

The present invention will now be described in terms of various preferred embodiments thereof, and with reference to the drawings.

### The First Preferred Embodiment

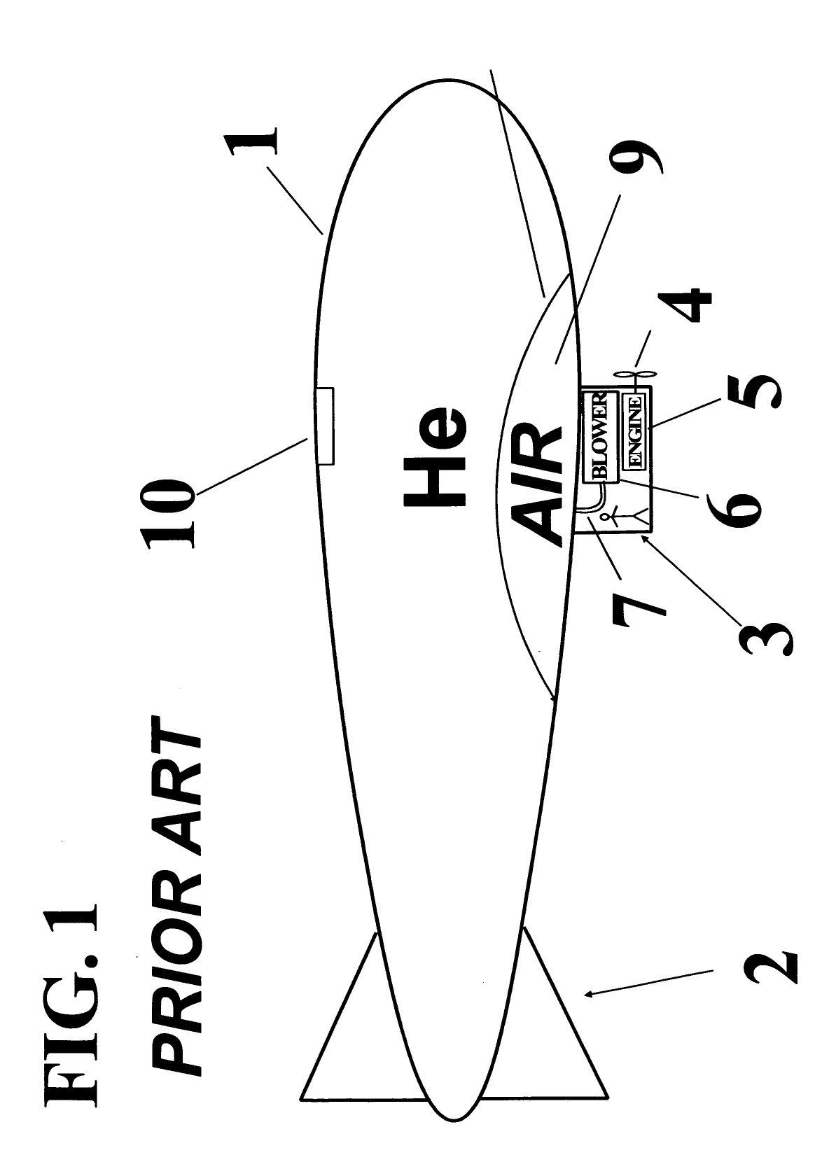

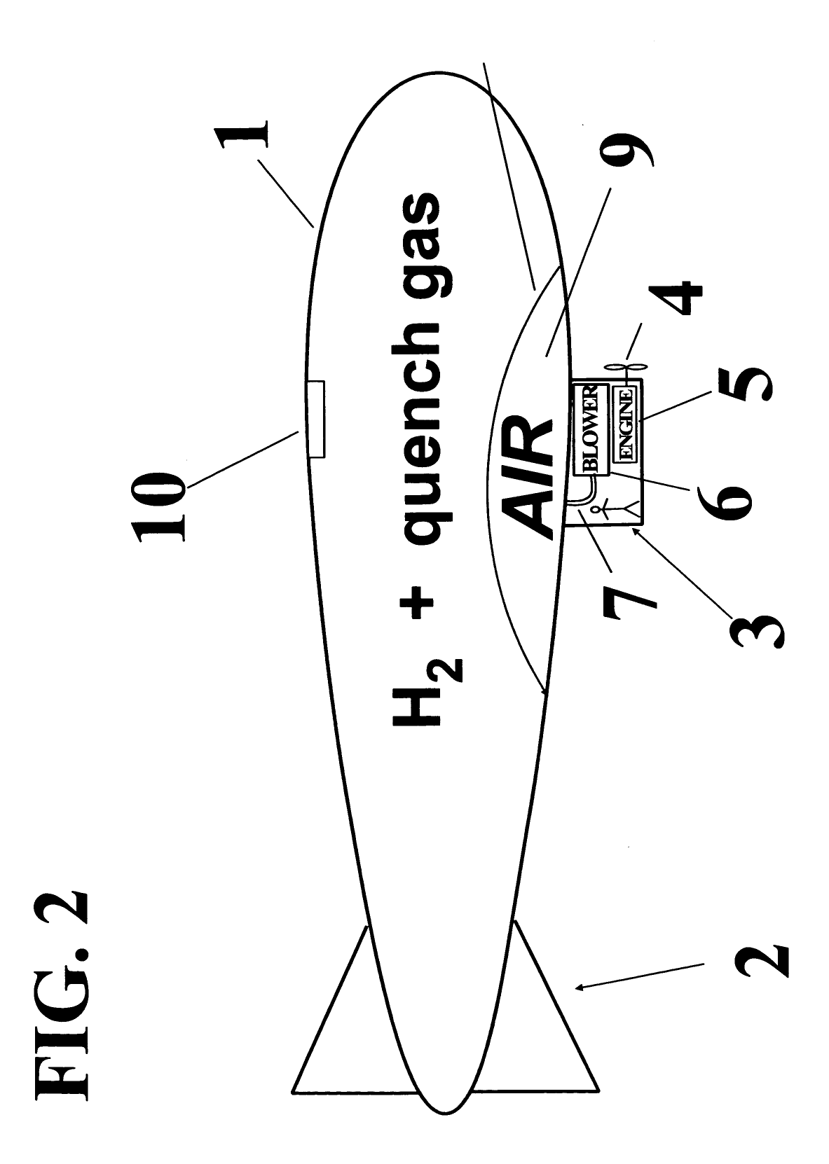

FIG. 2 shows the first preferred embodiment of the airship of the present invention. This airship differs from the prior art airship shown in FIG. 1 and described above, in that the main volume of the envelope 1 is filled, not with helium, but with a mixture of hydrogen (H₂) and a gaseous agent which, in the proportion utilized, has the property of inhibiting the combustion of hydrogen in air and rendering it non-flammable, at least to a certain extent. This gaseous agent will be referred to as the “quench gas”.

Possibilities for the Quench Gas

The most classical gaseous halon gas type fire extinguishing agent is Halon 1301-bromotrifluoromethane CF₃Br. This substance is a well established fire extinguishing agent in the conventional context, but it suffers from the disadvantage that its release is quite deleterious to the environment. However, depending upon the amount involved, this may not be an insuperable barrier to its utilization, especially in view of the additional precautions against release of the quench gas which are detailed hereinafter with reference to the second through the sixth preferred embodiments of the present invention.

Another classical halon gas is Halon 1211-bromochlorodifluoromethane CF₂ClBr. This is also suspect from the point of view of environmental degradation, but it is an effective fire extinguishing agent.

Certain so called halon replacement gases are nowadays being studied and utilized in the firefighting context. It should be noted that, in the particular context of a quench gas for airship use, the property of low toxicity to human beings in a confined space is not actually a priority, because confined spaces are not involved. The following gases can be considered as possibilities for the gaseous fire extinguishing agent to be used with the present invention:
(a) FM-200 (trademark), HFC-227ea (CF₃—CHF—CF₃), heptafluoropropane, manufactured by the Great Lakes Chemical Corporation;
(b) FE-13 (trademark), HFC-23 (CHF₃), trifluoromethane, manufactured by Dupont;
(c) CEA-410 (trademark), FC-3-1-10 (C₄F₁₀), perfluorobutane, manufactured by 3M Corporation;
(d) FE-25 (trademark), HFC-125 (CF₃CF₂H), pentafluoroethane, manufactured by Dupont;
(e) FE-36 (trademark), HFC-236fa (CF₃CH₂CF₃), hexafluoropropane, manufactured by Dupont;
(f) ITM (trademark), (CF₃I), trifluoroiodomethane, manufactured by AJAY;
(g) FE-241 (trademark), (CHClFCF₃), chlorotetrafluoroethane, manufactured by Dupont.

A mixture of two or more of the above gases may also prove to be effective.

Novel Extinguishing Action

It should be understood that the application of a gaseous fire extinguishing agent as a quench gas for airship use is actually a radically different form of application, from conventional fire extinguishing use. That is, when such a gaseous agent is used in a conventional manner for extinguishing a fire in a restricted space such as, for example, a computer room or an engine room, a typical sequence of events is as follows:
(1) Due to a short circuit or the like, a source of ignition comes into being, and a combustible material such as insulation or the like starts to be heated up;
(2) This hot material starts to evolve flammable gases at high temperature;
(3) A combustion reaction starts between these hot flammable gases and the oxygen in the air currently present in the restricted space, and flames and/or smoke are generated;
(4) This fact is detected by a sensor system, which triggers the venting of a container of the gaseous fire extinguishing agent into the air in the restricted space, and quickly the agent dissipates throughout said restricted space and attains a certain effective concentration in intimately mixed relation with the oxygen therein;
(5) The flames which are being generated by the reaction between the hot flammable gases and the oxygen, are extinguished by the action of various chemical reactions with the molecules of the fire extinguishing agent, which are mixed with the air.

By contrast, in the case of the present invention, no sensor system is provided. The gaseous fire extinguishing agent is mixed with the hydrogen lift gas in advance and is uniformly distributed therethrough. The contrast with conventional art is that, according to the present invention, the gaseous fire extinguishing agent is not distributed through any mass of air containing oxygen, but instead is uniformly distributed through the potential fuel which might be involved in a fire—the hydrogen lift gas. Accordingly, if a hydrogen leak should occur and the escaping hydrogen should come into contact with a potential source of ignition, such as an electrical spark or a hot portion of an engine, there is no portion of the hydrogen which is not already in intimate contact with gaseous fire extinguishing agent. It is therefore thought that relatively low proportions of gaseous fire extinguishing agent will be sufficient for providing effective extinguishing action.

Benefits

The benefit reaped from the use, according to this first preferred embodiment of the present invention, of a lift gas mixture medium consisting of hydrogen mixed with a quench gas, are as follows.

First, the lift gas mixture medium is non-flammable, thus avoiding the well-known fire and explosion problems associated with the use of pure hydrogen.

Secondly, the lift gas mixture medium is relatively cheap. Hydrogen can be made by a number of per se well-known processes, and is commonly used in industry. Nowadays the cost of hydrogen is several orders of magnitude lower than that of helium. Moreover, the quench gas is not required in very large quantity, nor are any of the various possibilities very expensive.

Thirdly, the raw materials from which hydrogen may be made can be transported easily, since they are solids and liquids rather than gases. Therefore it is perfectly possible to manufacture the hydrogen which is the basis of the lifting medium according to the present invention, using an on-site apparatus located at the point where the airship is to be inflated. This avoids all the great difficulties and expenses associated with transporting helium long distances in cylinders. Alternatively the hydrogen may be made in an industrial facility, not actually located at the point where the airship is to be inflated, but quite near thereto. In such a case it will be necessary to transport the hydrogen in cylinders for a short distance to the inflation point, but the trouble and expense involved will be much less than in the case of transporting helium for thousands of kilometers. And there is little difficulty in transporting the quench gas in cylinders to the point where the airship is to be inflated, because the quantity thereof which is required is relatively low. Of course the actual operation of mixing the quench gas with the hydrogen is, per se, very easy.

Finally, the lift gas mixture medium according to the present invention can be expected to provide a lift value closer to that of pure hydrogen, than to that of pure helium. In the present state of experimental knowledge it is not possible to state precisely what weight proportions of various quench gases should be added to hydrogen, in order to result in a suitably non-flammable mixture. (It should be noted that it is not strictly necessary to render the mixture absolutely non-flammable, provided that its ignitability and/or combustibility are substantially reduced.) However the density of helium is about twice that of hydrogen. It may be expected that the weight of quench gas that needs to be added into hydrogen for partial or complete flammability nullification will be a relatively small proportion of the weight of the flammable matter (the hydrogen) that is to be treated. Accordingly the lifting medium according to the present invention can be expected to have a better lifting power than helium, which is a significant advantage, since modest increases in lift gas lifting power become translated into much greater proportional increases in airship payload capability.

### The Second Preferred Embodiment

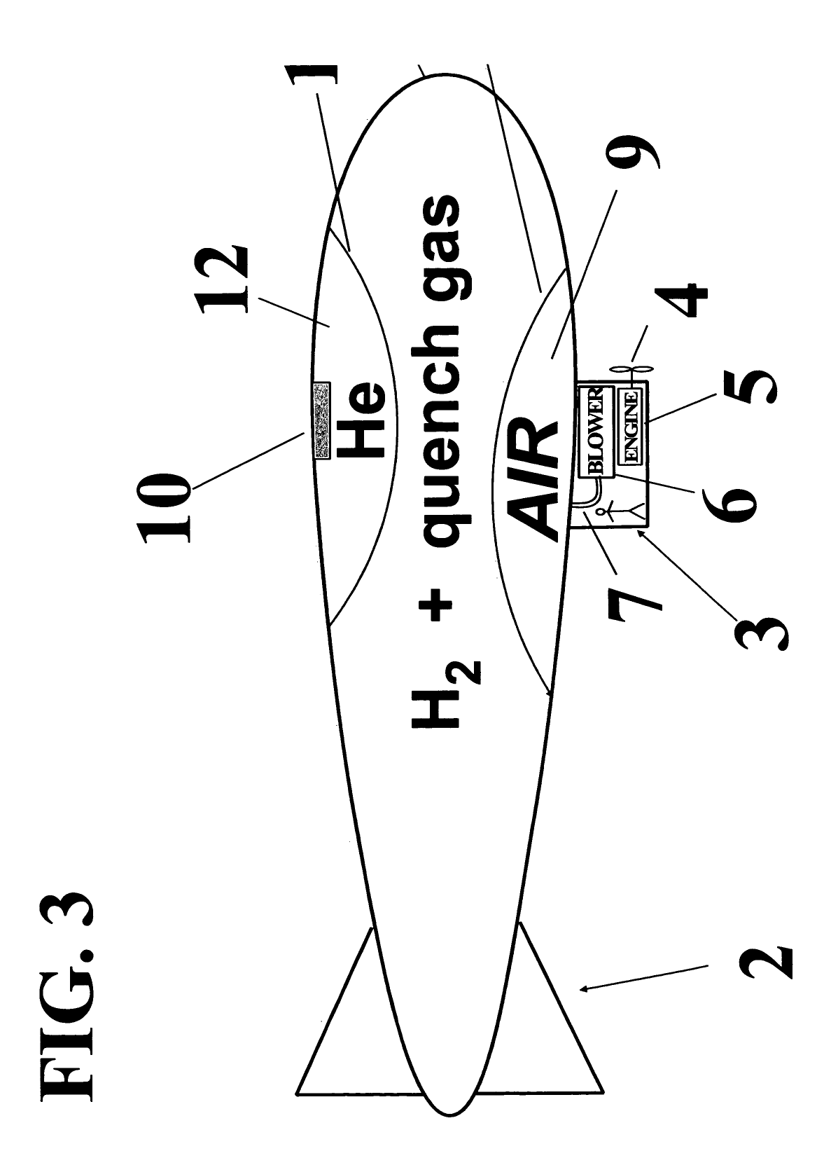

FIG. 3 shows the second preferred embodiment of the airship of the present invention. This airship differs from the first preferred embodiment airship shown in FIG. 2 and described above, in that it is provided with a vent gas chamber.

In detail, an upper portion of the interior space of the envelope 1 is divided from the rest by a separating membrane 11, so as to define the vent gas chamber 12, into which the emergency pressure relief valve 10 opens. And, during use of the airship, the main volume of the envelope 1 is filled with a mixture of hydrogen and quench gas (as with the first preferred embodiment), while the vent gas chamber 12 is filled with helium.

The purpose of this arrangement is to avoid venting any of the quench gas to the outside, even if the airship inadvertently rises above its pressure ceiling. Some of the possibilities for the quench gas may be considered to be harmful to the environment, if vented. The ascent of the airship above its pressure ceiling, which necessitates the venting of lift gas, does not constitute a full scale emergency although it should not occur, and it may happen inadvertently from time to time even during routine operations. If this happens and the pressure relief valve 10 opens, then a certain quantity of helium will be vented, rather than a mixture of hydrogen and quench gas as with the first preferred embodiment, and this may be considered to be advantageous from the point of view of the environment, even allowing for the high cost of helium.

### The Third Preferred Embodiment

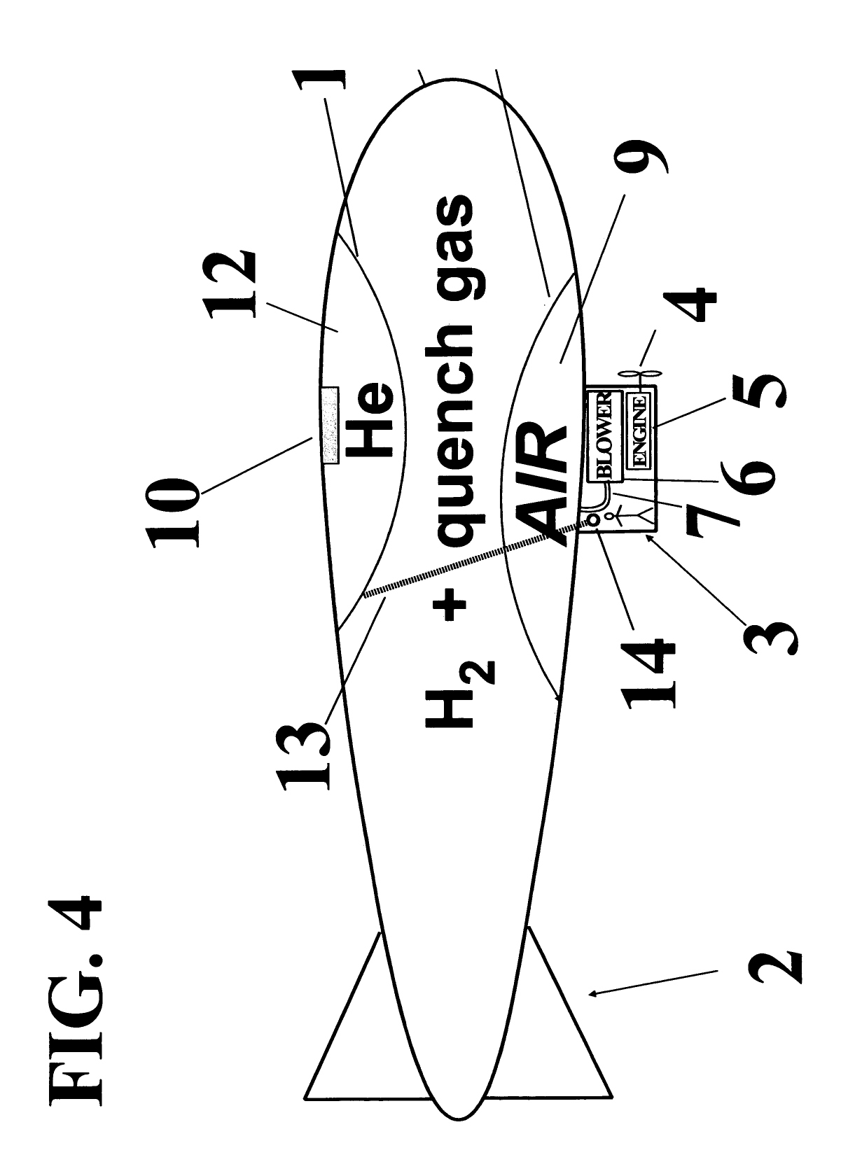

FIG. 4 shows the third preferred embodiment of the airship of the present invention. This airship differs from the second preferred embodiment airship shown in FIG. 3 and described above, in that a cable 13 and a pull ring 14 are provided for ripping a large aperture in the separating membrane 11 which defines the vent gas chamber 12. These arrangements are provided in order to allow for venting of the mixture of hydrogen and quench gas in the main volume of the envelope 1, if venting of the helium in the vent gas chamber 12 through the relief valve 10 proves to be inadequate for coping with a rapid ascent.

### The Fourth Preferred Embodiment

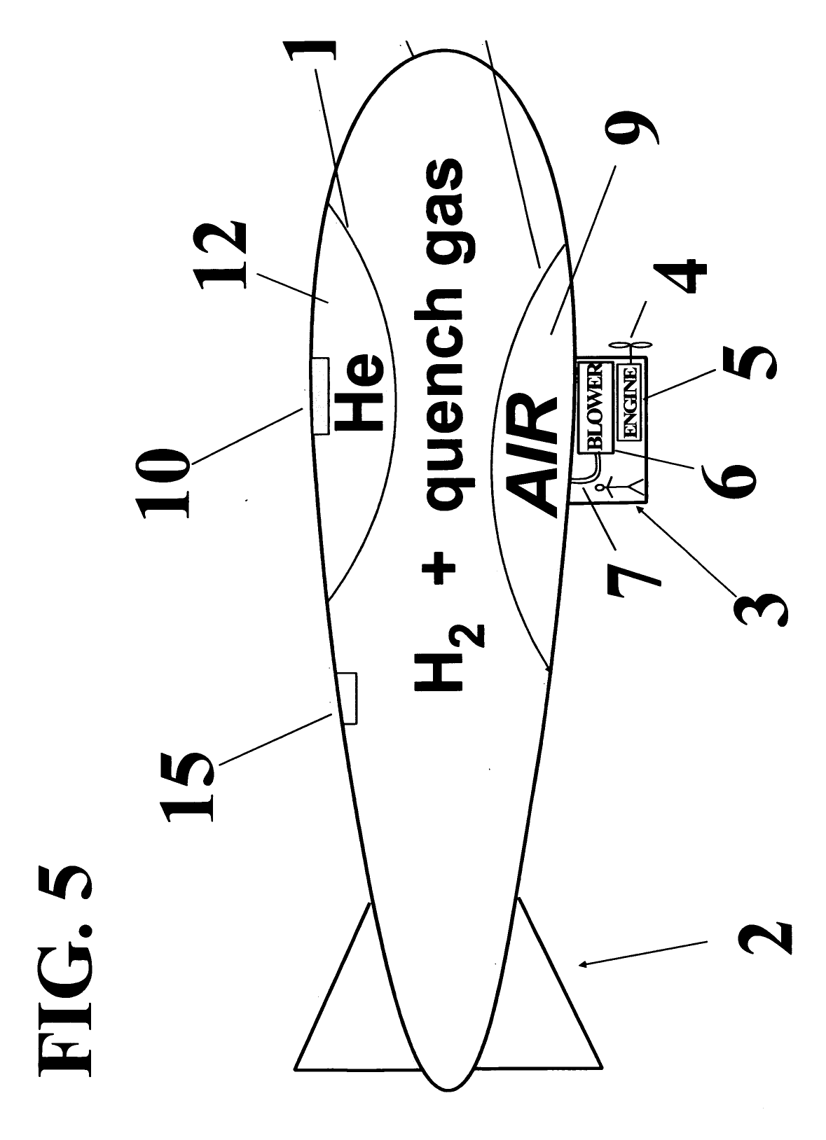

FIG. 5 shows the fourth preferred embodiment of the airship of the present invention. This airship differs from the second preferred embodiment airship shown in FIG. 3 and described above, in that a second pressure relief valve 15 is provided, opening into the main volume of the airship 1 which again is filled with a mixture of hydrogen and quench gas. This second pressure relief valve 15 should be set to blow off at a pressure substantially greater than the first pressure relief valve 10, while at the same time of course still being well below the burst pressure of the envelope 1.

This second relief valve 15 is again provided in order to allow for venting of the mixture of hydrogen and quench gas in the main volume of the envelope 1, if venting of the helium in the vent gas chamber 12 through the first relief valve 10 should prove to be inadequate for coping with a rapid ascent. The blow off pressure of the second relief valve 15 is set to be substantially greater than that of the first pressure relief valve 10, in order to ensure that the helium in the vent gas chamber 12 is vented first, before any question arises of venting the mixture of hydrogen and quench gas in the main volume of the envelope 1. This venting of the main volume of the envelope 1 will, thus, only be performed in the case of a serious emergency.

### The Fifth Preferred Embodiment

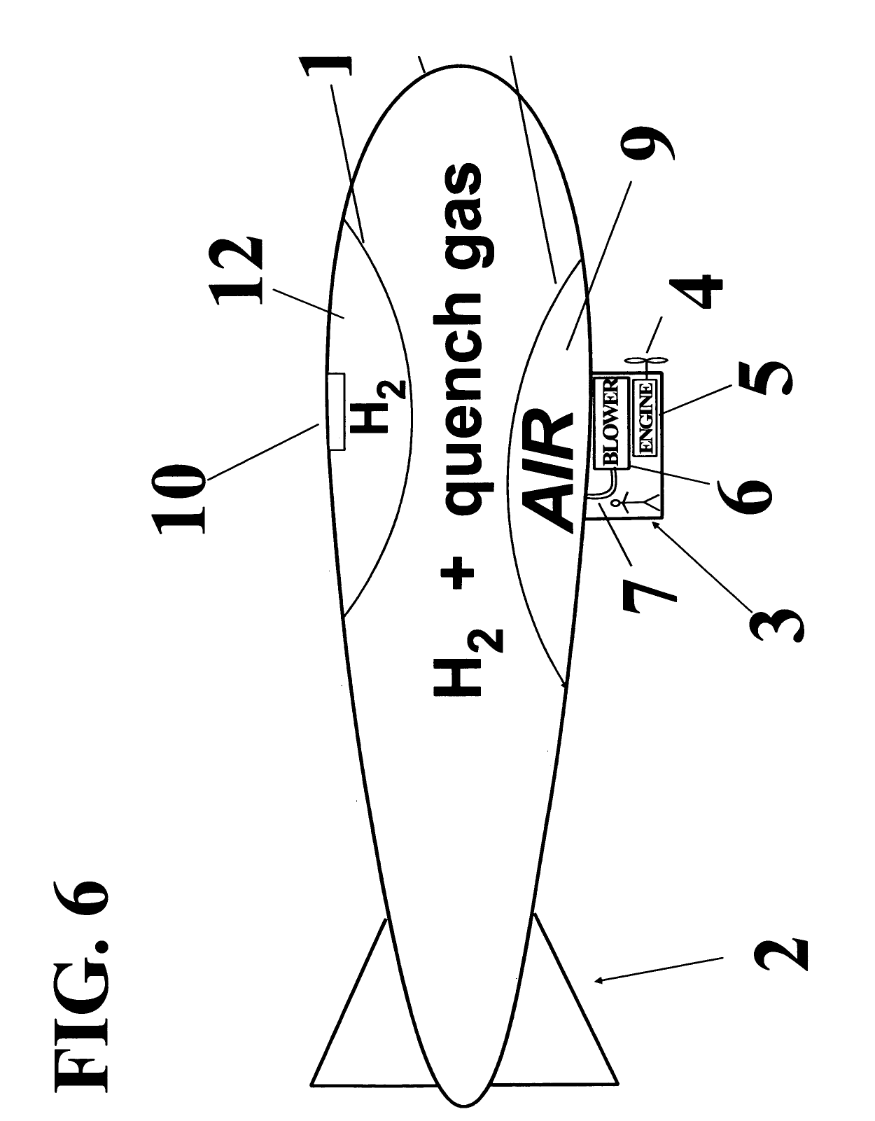

FIG. 6 shows the fifth preferred embodiment of the airship of the present invention. This airship differs from the second preferred embodiment airship shown in FIG. 3 and described above, in that the vent gas chamber 12 is filled with pure hydrogen, rather than helium. As before, the main volume of; the envelope 1 is filled with a mixture of hydrogen and quench gas.

The rationale behind this fifth preferred embodiment is that the presence of pure hydrogen (which is flammable) in the upper portion of the airship envelope 1, may be considered not to involve an intolerable degree of risk. That is, the potential sources of ignition in the airship structure are principally associated with the operation of the engine 5 (which is typically an internal combustion engine) and with the operation of various electrical and electronic gear associated with the car 3 and possibly with the empennage 2. By contrast, there is no electrical or electronic gear located anywhere near the upper portion of the airship envelope 1, or near the vent gas chamber 12. Moreover, if hydrogen in the vent gas chamber 12 were to be vented through the pressure relief valve 10, it would naturally rise in the atmosphere, and would clear the airship completely, since it is much lighter than air. The practical likelihood of ignition or explosion of such hydrogen in the vent gas chamber 12, accordingly, may be viewed as negligible.

And the cost benefit of filling the vent gas chamber 12 with hydrogen, rather than with helium as was done with the second through fourth preferred embodiments, is considerable. A certain lift benefit is also attained, as compared with the use of helium.

### The Sixth Preferred Embodiment

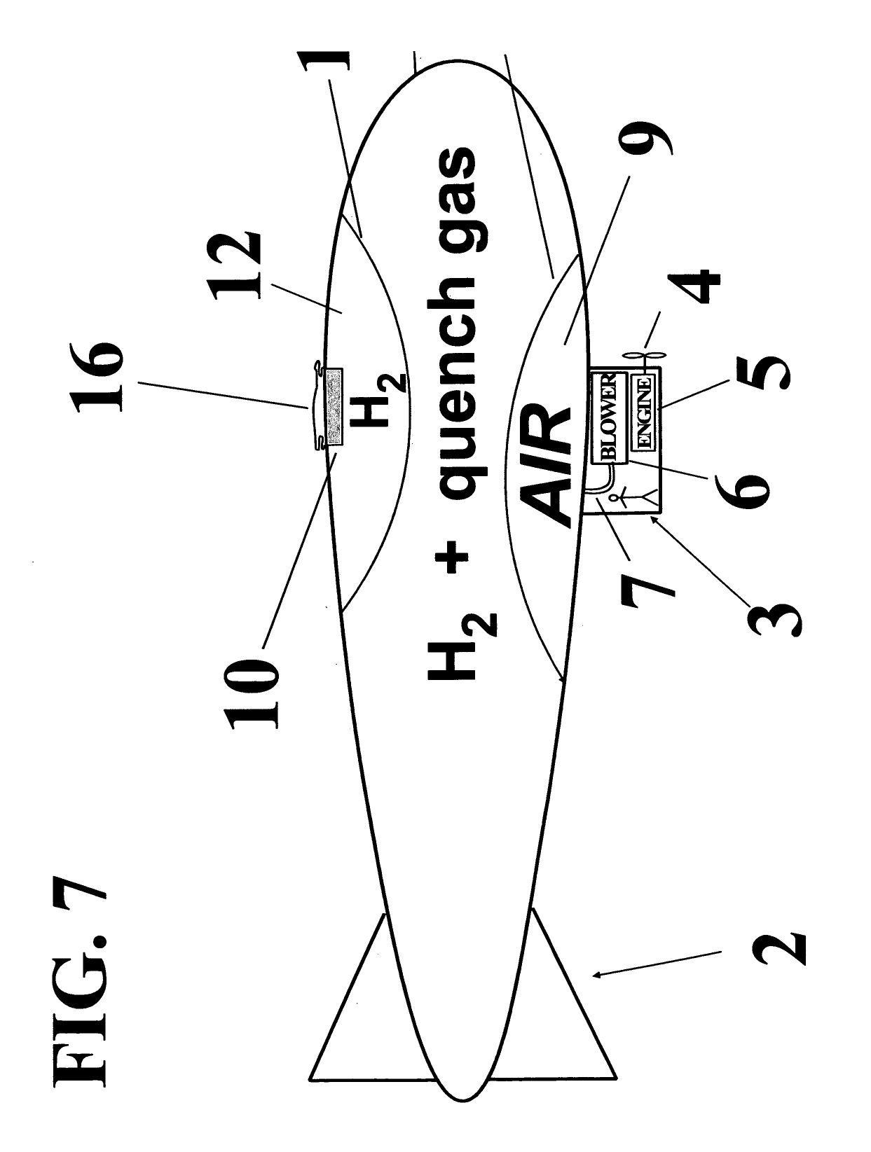

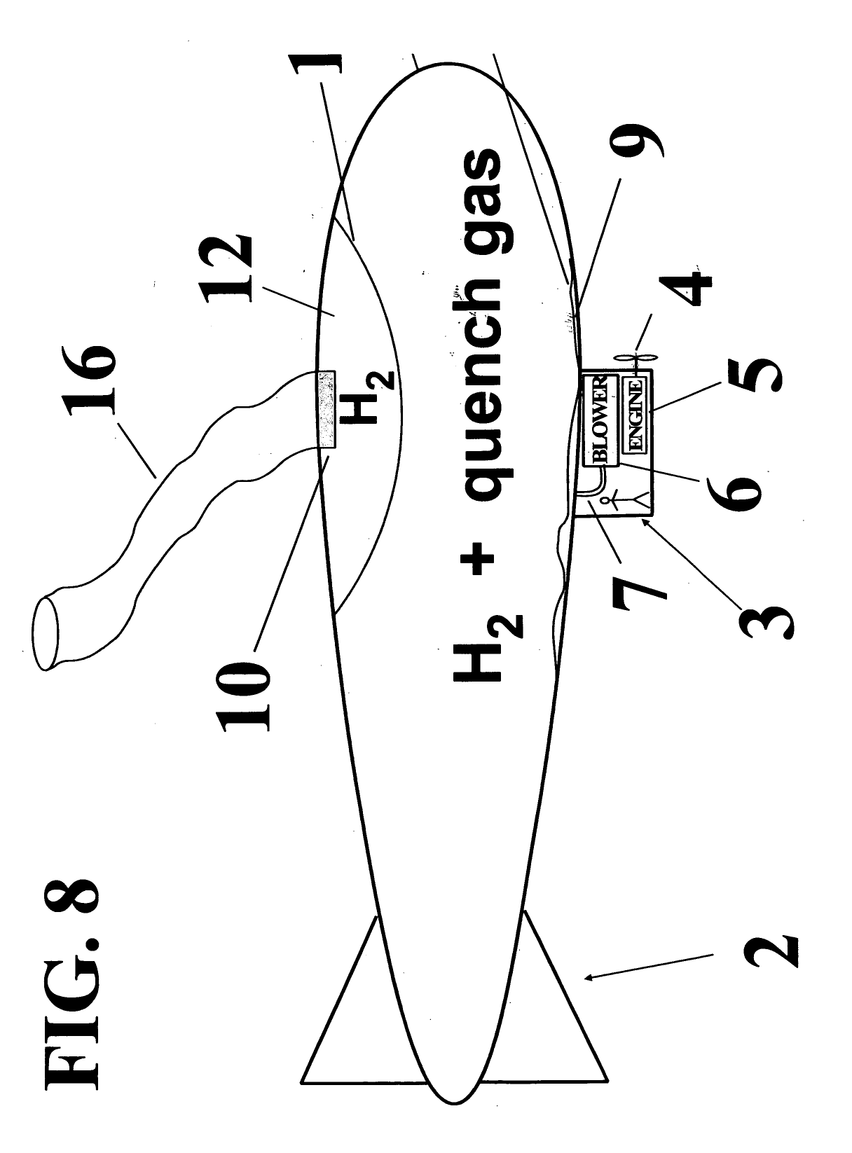

FIGS. 7 and 8 show the sixth preferred embodiment of the airship of the present invention. In this sixth preferred embodiment, as with the fifth preferred embodiment, the vent gas chamber 12 is filled with pure hydrogen. However, this airship differs from the fifth preferred embodiment airship shown in FIG. 6 and described above, in that a vent tube 16 is additionally provided. This vent tube 16 is made from a flexible fabric material, and in normal use of the airship, as shown in FIG. 7, it is stowed in collapsed form just above the pressure relief valve 10.

However, if the airship rises and reaches its pressure ceiling so that the ballonet 9 is completely collapsed, and then (undesirably) continues to rise so that hydrogen is vented from the vent gas chamber 12, then as shown in FIG. 8, the vent tube 16 is deployed. Naturally the hydrogen venting through the tube 16 will raise it upwards to project away from the envelope 1, and this will ensure that the escaping hydrogen is vented at a great height relative to the airship lower portion, well away from any potential sources of ignition that may be present in the car 3 or the empennage 2. This confers an additional degree of safety, and may be considered to remove any residual degree of risk associated with the use of pure hydrogen in the vent chamber 12.

Disclaimer

Although the present invention has been shown and described in terms of various preferred embodiments thereof, and with reference to the drawings, it should not be considered as being limited or defined by any of the perhaps purely adventitious features of the embodiments or of the drawings, but only by the accompanying Claims.

1. A lifting medium for an LTA craft, comprising a mixture of hydrogen and a quench gas which has a fire extinguishing action.

2. A lifting medium for an LTA craft according to claim 1, wherein said quench gas is Halon 1301 bromotrifluoromethane(CF₃Br).

3. A lifting medium for an LTA craft according to claim 1, wherein said quench gas is Halon 1211 bromochlorodifluoromethane(CF₂ClBr).

4. A lifting medium for an LTA craft according to claim 1, wherein said quench gas is HFC-227ea (CF₃—CHF—CF₃)heptafluoropropane.

5. A lifting medium for an LTA craft according to claim 1, wherein said quench gas is HFC-23 (CHF₃)trifluoromethane.

6. A lifting medium for an LTA craft according to claim 1, wherein said quench gas is FC-3-1-10 (C₄F₁₀)perfluorobutane.

7. A lifting medium for an LTA craft according to claim 1, wherein said quench gas is HFC-125 (CF₃CF₂H)pentafluoroethane.

8. A lifting medium for an LTA craft according to claim 1, wherein said quench gas is HFC-236fa (CF₃CH₂CF₃)hexafluoropropane.

9. A lifting medium for an LTA craft according to claim 1, wherein said quench gas is trifluoroiodomethane (CF₃I).

10. A lifting medium for an LTA craft according to claim 1, wherein said quench gas is FE-241 (CHClFCF₃)chlorotetrafluoroethane.

11. A lifting medium for an LTA craft according to claim 1, wherein said quench gas is a mixture of two or more of the quench gases specified in claims 2 through 10.

12. An LTA craft buoyed by a gas according to any one of claims 1 through 11.

13. An LTA craft comprising an envelope containing a gas according to any one of claims 1 through 11.

14. An LTA craft comprising an envelope comprising a main chamber, a vent chamber generally above said main chamber and separated therefrom by a separating membrane, and a first pressure relief valve opening between said vent chamber and the external atmosphere, which opens at a certain first threshold pressure.

15. An LTA craft according to claim 14, further comprising means for ripping said separating membrane.

16. An LTA craft according to claim 14, further comprising a second pressure relief valve opening between said main chamber and the external atmosphere, said second pressure relief valve opening at a second threshold pressure which is substantially greater than said first threshold pressure.

17. An LTA craft according to claim 14, further comprising a flexible tube fitted to lead from the outside of said first pressure relief valve outward away from said envelope.

18. An LTA craft according to any one of claims 14 through 17, wherein said main chamber is filled with a lifting medium according to any one of claims 1 through 11.

19. An LTA craft according to claim 18, wherein said vent chamber is filled with helium.

20. An LTA craft according to claim 18, wherein said vent chamber is filled with hydrogen.
